(19) United States
(12) Patent Application Publication
(10) Pub. No.: US 2018/0066687 A1
(43) Pub. Date: Mar. 8, 2018

(54) DRIVE ARRANGEMENT FOR DRIVING AN ACTUATOR ELEMENT

(71) Applicant: SCHAEFFLER TECHNOLOGIES AG & CO. KG, Herzogenaurach (DE)

(72) Inventor: Sebastian WEIS, Breitenbach (DE)

(73) Assignee: SCHAEFFLER TECHNOLOGIES AG & CO. KG, Herzogenaurach (DE)

(21) Appl. No.: 15/551,638

(22) PCT Filed: Jan. 28, 2016
(86) PCT No.: PCT/DE2016/200058

§ 371 Date: Aug. 17, 2017

(30) Foreign Application Priority Data
Feb. 20, 2015 (DE) 10 2015 203 090.3

(51) Int. Cl. F16B 7/04; B62M 25/08

(52) U.S. Cl. CPC F16B 7/042; F16B 21/186; B62M 25/08

(57) ABSTRACT

A drive arrangement for driving an actuator is provided. The drive arrangement includes a drive device and a housing part which can be connected to or is connected to the drive device. At least one first plug-in element is arranged or configured on the drive device in the form of a pin- or peg-like plug-in projection. At least one second plug-in element corresponding to the at least one first plug-in element is arranged or configured on the housing part, and includes bore-like sockets. The drive device is connectable to the housing part via a plug-in connection at the first plug-in element and the second plug-in element.

### CROSS-REFERENCE TO RELATED APPLICATIONS

This application is the U.S. National Phase of PCT/DE2016/200058 filed Jan. 28, 2016, which claims priority to DE 102015203090.3. filed Feb. 20, 2015, the entire disclosures of which are incorporated by reference herein.

### TECHNICAL FIELD

This disclosure relates to a drive assembly for driving an actuator element, comprising a drive device and housing part that can be or is attached to the drive device.

### BACKGROUND

Drive assemblies of this type are fundamentally known in different embodiments with respect to their construction and function. A common field of application and use of such a drive assembly lies in the field of two-wheel vehicle technology, in particular bicycle technology, in which drive assemblies of this type are provided for driving or actuating an actuator element belonging to a shifting device, e.g. a chain or hub gear shifter.

The installation of such a drive assembly typically takes place such that corresponding drive devices are attached to corresponding housing parts by means screw connections.

Because comparatively “small” components or component assemblies are used, in particular in the aforementioned field of two-wheel technology, both in the drive devices as well as in the housing parts, correspondingly “small” screws and screw threads are used accordingly.

As a result, the automated installation of such drive assemblies can be difficult.

The object of the invention is to create an improved drive assembly for driving an actuator element, in particular with respect to a simple installation.

### SUMMARY

This problem is solved by a drive assembly with at least one first plug-in element (also referred to as a surface feature) being disposed or formed on the drive device in the form of a pin-like or peg-like projection or in the form of a bore-like socket, and at least one second plug-in element (also referred to as a surface feature), corresponding to the at least one first plug-in element on the drive device is disposed or formed on the housing part in the form of a bore-like socket or in the form of a pin-like or peg-like projection, wherein the drive device can be or is non-rotatably connected to the housing part by means of a plug-in connection that can be or is formed by the interaction of the, or at least one, first plug-in elements on the drive device and the, or at least one, second plug-in elements on the housing.

In one embodiment, the drive assembly comprises a drive device and a housing part. The drive device comprises an, e.g. electrical, drive motor, as well as a drive device coupled thereto such that the drive device rotates about an axis. The housing part delimits a receiving space, in which certain components of the drive assembly can be or are disposed. The components that are or can be disposed in the receiving space delimited by the housing part include, e.g., a bearing element, e.g. a roller bearing, for supporting a spindle element, as well as certain parts of the drive device, e.g. a drive shaft, which extends into the receiving space delimited by the housing part at least in part, when the drive device is connected to the housing part.

In one embodiment, the drive device is provided with at least one, or numerous, plug-in elements. The plug-in elements on the drive device are referred to as first plug-in elements. Thus, such first plug-in elements are disposed or formed on the drive device. These first plug-in elements are disposed or formed on an end surface of the drive device, as long as the drive device is a cylindrical component or a cylindrical assembly. The first plug-in element can be a pin-like or peg-like projection, or alternatively they can be a bore-like socket. If numerous first plug-in elements are disposed or formed on the drive device, it is of course also possible for there to be both first plug-in elements in the form of pin-like or peg-like projections, and first plug-in elements in the form of bore-like sockets.

The housing part can also be provided with at least one, or numerous, plug-in elements. The plug-in elements on the housing part are referred to as second plug-in elements. Thus, such second plug-in elements are disposed or formed on the housing part. These second plug-in elements can also be disposed or formed on an end surface of the housing part as well, as long as the housing part is a cylindrical, in particular a hollow cylindrical, component, or a cylindrical, in particular hollow cylindrical, assembly. The second plug-in element can likewise be a bore-like socket or a pin-like or peg-like projection corresponding to connect with the first plug-in elements. If numerous second plug-in elements are disposed or formed on the housing part, it is of course also possible for there to be both second plug-in elements in the form of pin-like or peg-like projections, and second plug-in elements in the form of bore-like sockets.

A pin-like or peg-like projection is understood in general to be a component projecting or protruding from a base surface or base surface section, or a component section projecting or protruding from a base surface or base surface section. The component or component section has the geometric shape of a pin or peg.

A bore-like socket is understood in general to be a recess or opening formed in a base surface or in a base surface section. The recess or opening has the geometric shape of a bore, or is a bore, e.g., a through-bore or a blind bore.

It is important that the second plug-in elements in the housing part correspond to the first plug-in elements on the drive device with respect to their function and structure, and vice versa. A first plug-in element and a second plug-in element corresponding thereto can be referred to or regarded in this respect as corresponding plug-in partners of a plug-in connection. With respect to the specified embodiments of the respective first and second plug-in elements as either a projection or a socket, this means that for each first plug-in element designed as a projection, there is a second plug-in element having a socket corresponding to the projection, into which the projection can be inserted. Accordingly, for a first plug-in element designed as a socket, there is a second plug-in element having a projection corresponding to the socket, which can be inserted into the socket.

The drive device can be connected to the housing part through the interaction of the respective first plug-in element on the drive device, and the respective second plug-in element on the housing part. This is a non-rotatable plug-in connection, e.g., not suitable for transferring torques. In other words, the drive device can be or is non-rotatably connected to the housing part by means of a plug-in connection that can be or is formed by the interaction of the, or at least one, first plug-in elements on the drive device and the, or at least one, second plug-in elements on the housing part.

In this manner, with respect to the installation of the drive assembly, a significantly simplified means is obtained for connecting a corresponding drive device to a corresponding housing part.

The drive device can be or is attached to the housing part by means of, or via, at least one clamping element, when it is connected to the housing part. The drive assembly can thus comprise at least one clamping element, via which the drive device can be attached to the housing part, typically such that it cannot become unintentionally detached. An attachment is understood in particular to be an axial attachment, via which the axial position of the drive device connected to the housing part is fixed in relation to the housing part. The attachment can be releasable (without damage or destruction) or non-releasable.

Such a clamping element can be a clamping washer or it can comprise at least one clamping washer. A clamping washer is typically a ring-shaped or annular disk-shaped component in the manner or shape of a retaining ring or a locking ring for the axial securing of different objects that are to be attached to one another.

When the drive device is connected to the housing part, the clamping washer, or in general, such a clamping washer, can be supported with a first attachment section on a cylindrical bearing section of the drive device extending at least in part into the housing part, and with a second attachment part on an inner surface, e.g. an inner base surface, of the housing part. Respective attachment sections on the clamping washer are formed on or in the regions of the outer and inner circumferences of the clamping washer. In a correctly installed state on a corresponding cylindrical bearing section of the drive device, a first attachment section of the clamping washer is located in the region of the inner circumference of the clamping washer, and thus on a radially inner position with respect to the axis of symmetry of the clamping washer in comparison to the second attachment section, which is accordingly located on the outer circumference, and thus at a radially outer position with respect to the axis of symmetry of the clamping washer.

In one embodiment, a drive shaft of the drive device passes through the cylindrical bearing section. The drive shaft of the drive can be directly or indirectly coupled to the actuator element that can be or is driven via the drive assembly. The cylindrical bearing section thus has a passage for a drive shaft protruding from the drive device, and thus typically exhibits a hollow cylinder or sleeve-like geometry. The cylindrical bearing section is disposed or formed on a non-rotatably supported section of the drive device. The cylindrical bearing section is thus not moveably coupled to the drive shaft passing through it. Thus, rotational movements of the drive shaft do not cause rotational movements of the cylindrical bearing section. Nevertheless, there may be a sliding contact between the inner circumference of the cylindrical bearing section and the outer circumference of the drive shaft passing through it. Accordingly, the cylindrical bearing section can be formed from a material having good sliding properties, e.g. brass, at least in the region of its inner circumference, and/or it may be provided with a coating of a material having good sliding properties.

It has been noted that the at least one first plug-in element can be disposed or formed on an end surface of the drive device, and that at least one second plug-in element can be disposed or formed on an end surface of the housing part that is disposed or formed opposite this end surface on the drive device. The respective first and second plug-in elements can be disposed or formed on the circumference, such that they are distributed evenly or unevenly on the respective end surfaces of the drive device (2) and the housing part (3).

The drive device can be or is coupled, indirectly or directly, to an actuator element, when it is connected to the housing part. The coupling of the drive device to a corresponding actuator element takes place via the, or in general, one of the drive shafts protruding from the drive device. An indirect coupling is a coupling of the drive device to the actuator element with at least one further component incorporated therebetween. Such a component can be, e.g., a rotatably supported coupling and/or spindle element. In concrete terms, the drive shaft can be non-rotatably coupled to a corresponding coupling element. The coupling element can in turn be non-rotatably coupled to a corresponding spindle element. An attachment section, e.g. in the form of a spindle nut, can be disposed or formed on the spindle element, for attaching an actuator element that can be or is driven, e.g. a gear cable. A direct coupling, accordingly, is understood to be a coupling of the drive device to the actuator element without incorporating any components therebetween.

This disclosure also relates to a shifting device for a two-wheeled vehicle, in particular for a bicycle. The shifting device, e.g. a chain or hub shifter, comprises an actuator element that can be or is driven via a drive assembly, as described, e.g. a gear cable. All of the explanations given in the context of the drive assembly apply analogously to those given in the context of the shifting device.

### BRIEF DESCRIPTION OF THE DRAWINGS

The disclosure below is based on exemplary embodiments, with reference to the drawings. The drawings are schematic diagrams, wherein:

FIG. 1 shows a view of a drive assembly according to an exemplary embodiment of the invention; and

FIG. 2 shows a partial view of a shifting device according to an exemplary embodiment of the invention.

### DETAILED DESCRIPTION

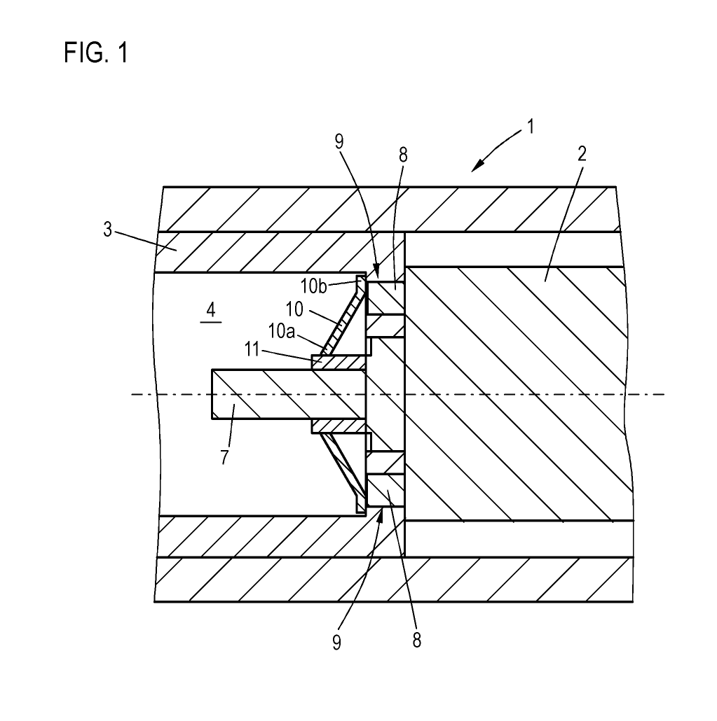

FIG. 1 shows a view of a drive assembly 1 according to an exemplary embodiment of the invention. The view shown in FIG. 1 is a cutaway view of the drive assembly 1.

The drive assembly 1 serves to drive an actuator element (not shown). The drive assembly 1 comprises a drive device 2 and a housing part 3.

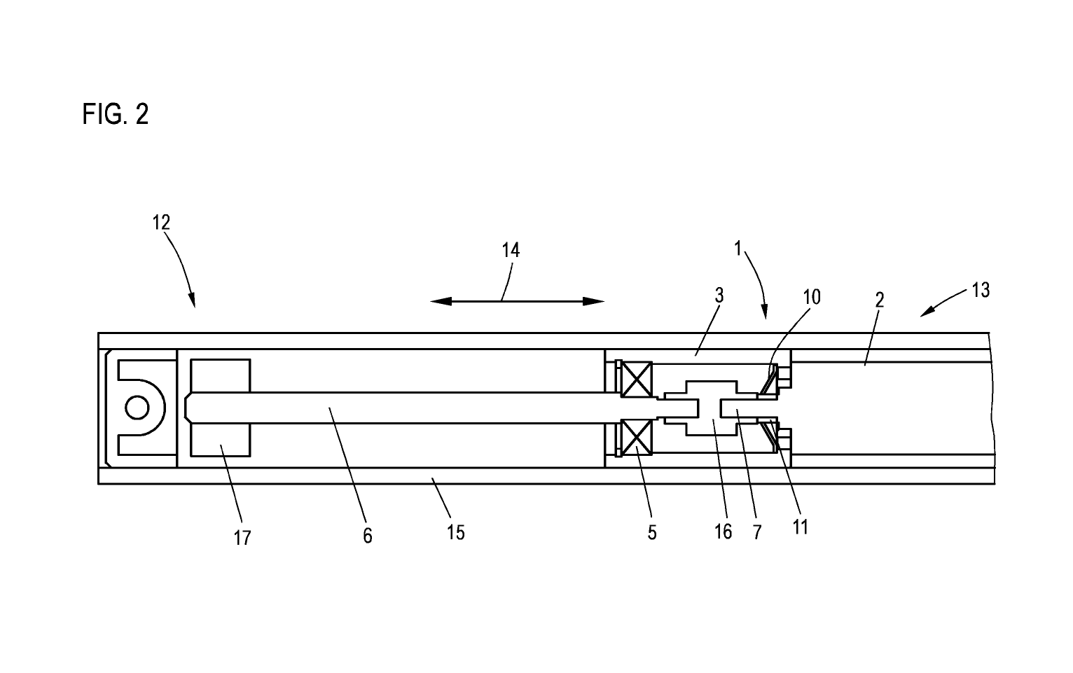

The drive device 2 comprises an, e.g. electrical, drive motor (not shown), as well as, optionally, a gear unit (not shown) coupled thereto. The housing part 3 delimits a receiving space 4, in which certain components of the drive assembly 1 can be or are disposed. A bearing element 5 (cf. FIG. 2) is included in the components that can be or are disposed in the receiving space 4 delimited by the housing part, typically a roller bearing for supporting a spindle element 6 (cf. FIG. 2), as well as certain parts of the drive device 2, e.g. a drive shaft 7, which extends, at least in part, into the receiving space 4 delimited by the housing part, when the drive device 2 is connected to the housing part 3.

First plug-in elements 8 are disposed or formed on the end surface of the cylindrical drive device 2. The first plug-in elements 8 in the exemplary embodiments shown in the Figures are each pin-like or peg-like projections. The first plug-in elements 8 can also be referred to or regarded as dowels.

Second plug-in elements 9 are disposed or formed on the end surface of the cylindrical housing part 3. The second plug-in elements 9 are each bore-like sockets in the exemplary embodiments shown in the Figures.

The second plug-in elements on the housing part correspond functionally and structurally to the first plug-in elements 8 on the drive device. A first plug-in element 8 and a corresponding second plug-in element 9 can be referred to or regarded in this respect as corresponding plug-in partners of a plug-in connection. With respect to the embodiments of the respective first and second plug-in elements 8, 9 depicted in the exemplary embodiments shown in the Figures, this means that for each first plug-in element 8 designed as a projection, there is a second plug-in element 9 having a socket corresponding to the projection, into which the projection can be inserted.

The drive device 2 can be connected to the housing part 3 through the interaction of the respective first plug-in element 8 on the drive device and the respective second plug-in element 9 on the housing part. This is a non-rotatable, i.e. not suitable for transferring torque, plug-in connection. The drive device 2 is thus connected in a non-rotatable manner to the housing part 3 by means of a plug-in connection that can be or is formed by the interaction of the respective first plug-in element 8 on the drive device and the respective second plug-in element 9 on the housing part.

In this manner, a substantially simplified concept for connecting a drive device 2 to a corresponding housing part 3 is implemented with respect to the installation of the drive assembly 1.

It should be noted that, even though it is not shown in the Figures, it would also be possible in theory for the first plug-in elements 8, or some of them, to be bore-like sockets. Analogously, the second plug-in elements 9, or some of them, could also be pin-like or peg-like projections.

It can be seen in FIG. 1 that the drive device 2 is attached to the housing part by means of a clamping element 10 when it is connected to the housing part 3. This attachment is understood to be an axial attachment, via which the axial position of the drive device 2 connected to the housing part 3 is fixed in relation to the housing part 3. The attachment of the drive device 2 to the housing part 3 cannot become unintentionally detached, but it can be either releasable (without damage or destruction) or non-releasable.

The clamping element 10 is a clamping washer, e.g., a ring-shaped or annular disk-shaped component in the manner of a retaining ring or locking ring, for the axial structural securing of different objects that are to be attached to one another.

It is clear that the clamping washer is supported on a cylindrical, e.g., hollow cylindrical, bearing section 11 of the drive device 3 extending into the housing part 3 with a radially inner first attachment section 10a with respect to the axis of symmetry of the clamping washer, in the state shown in FIG. 1, in which the drive device 2 is connected to the housing part 3, and on an inner surface, e.g., an inner base surface here, of the housing part 3 with a radially outer second attachment section 10b with respect to the axis of symmetry of the clamping washer. The respective attachment sections 10a, 10b on the clamping washer are thus formed on or in the region of the outer and inner circumferences of the clamping washer.

The drive shaft 7 of the drive device 2 passes through the hollow cylindrical, or sleeve-like bearing section 11. The hollow cylindrical bearing section 11 thus has a passage, not described in greater detail, for the drive shaft 7. As can be derived in conjunction with the following explanations of FIG. 2, the drive shaft 7 of the drive device 2 is that shaft that is coupled to the actuator element that can be or is driven via the drive assembly 1.

The hollow cylindrical bearing section 11 is disposed or formed on a non-rotatably supported section of the drive device 3. The hollow cylindrical bearing section 11 is thus not moveably coupled to the drive shaft 7 passing through it. Rotational movements of the drive shaft 7 therefore do not cause rotational movements of the hollow cylindrical bearing section 11. Nevertheless, a sliding contact can exist between the inner circumference of the hollow cylindrical bearing section 11 and the outer circumference of the drive shaft 7 passing through it. Accordingly, the hollow cylindrical bearing section 11 can be formed by a material having good sliding properties in the region of its inner circumference, e.g. brass, and/or it can be provided with a coating made of a material having good sliding properties, e.g. graphite.

FIG. 2 shows a partial view of a shifting device 12 according to an exemplary embodiment of the invention. The illustration shown in FIG. 2 is a cutaway view of the shifting device 12.

The shifting device 12 can form, e.g. a chain or hub shifter of a two-wheeled vehicle, in particular a bicycle. The shifting device 12 comprises an actuator 13, here a linear actuator, the degree of freedom of movement of which is indicated by the double arrow 14. The actuator 13 can be or is driven via the drive assembly 1. The actuator 13 comprises a hollow cylindrical, e.g., a sleeve-like or tube-like receiving element 15, in which the drive assembly 1, as well as other components of the actuator 13, to be explained in greater detail herein, are disposed or attached.

The drive device 2 can be or is coupled indirectly to an actuator element (not shown), e.g. a shift cable, when it is connected to the housing part 3. The coupling of the drive device 2 to a corresponding actuator element takes place via the drive shaft 7. It can be seen that the drive shaft 7 is non-rotatably coupled to a coupling element 16. The coupling element 16 is non-rotatably coupled to the spindle element 6, which is rotatably supported via the bearing element 5. There is an attachment section 17 formed on the spindle element 6, here in the form of a spindle nut, for attaching the actuator element that is to be, or is, driven.

### LIST OF REFERENCE SYMBOLS

1 drive assembly
2 drive device
3 housing part
4 receiving space
5 bearing element
6 spindle element
7 drive shaft
8 first plug-in element
9 second plug-in element
10 clamping element
10a first attachment section
10b second attachment section
11 bearing section
12 shifting device
13 actuator
14 double arrow
15 receiving element
16 coupling element
17 attachment section

1. A drive assembly for driving an actuator, comprising:
a drive device and a housing part connected to the drive device;
at least one first plug-in element including either a pin-like or peg-like projection, or a bore-like socket formed on the drive device; and
at least one second plug-in element corresponding to the at least one first plug-in element including either a bore-like socket or a pin-like or peg-like projection formed on the housing part;
wherein the drive device is non-rotatably connected to the housing part via a plug-in connection formed by an interaction of the at least one first plug-in elements on the drive device and the at least one second plug-in elements on the housing part.

2. The drive assembly according to claim 1, wherein the drive device is attached to the housing part via at least one clamping element.

3. The drive assembly according to claim 2, wherein the at least one clamping element includes a clamping washer.

4. The drive assembly according to claim 3, wherein the clamping washer is supported with a first attachment section on a cylindrical bearing section of the drive device extending at least in part into the housing part, and supported with a second attachment section on an inner surface of the housing part.

5. The drive assembly according to claim 4, wherein a drive shaft of the drive device passes through the cylindrical bearing section.

6. The drive assembly according to claim 1, wherein the at least one first plug-in element is a pin-like or peg-like projection, and the at least one second plug-in element is a bore-like socket.

7. The drive assembly according to claim 1, wherein the at least one first plug-in element is disposed or formed on an end surface of the drive device, and the at least one second plug-in element is disposed or formed on an end surface of the housing part disposed opposite the end surface of the drive device.

8. The drive assembly according to claim 7, wherein the respective first and second plug-in elements are disposed or formed on a circumference, such that they are distributed evenly or unevenly on the respective end surfaces of the drive device and the housing part.

9. The drive assembly according to claim 1, wherein the drive device is coupled directly or indirectly to an actuator element when it is connected to the housing part.

10. (canceled)

11. A drive assembly for a chain or hub gear shifter of a bicycle, the drive assembly comprising:
a generally cylindrical drive device having an end surface and a drive shaft extending along a central axis thereof and beyond the end surface, the end surface defining a plurality of first surface features thereon; and
a generally cylindrical housing having an interior receiving space configured to receive the drive shaft, the housing having an end surface defining a plurality of second surface features thereon configured to engage the first surface features to connect the drive device to the housing in a non-rotatable manner.

12. The drive assembly of claim 11, wherein the first surface features are projections and the second surface features are sockets, each socket sized and configured to receive and couple to a corresponding one of the projections.

13. The drive assembly of claim 11, wherein the first surface features are sockets are the second surface features are projections, each socket sized and configured to receive and couple to a corresponding one of the projections.

14. The drive assembly of claim 11, wherein the drive shaft is coupled to a coupling element that is, in turn, connected to a spindle supported for rotation within a bearing.

15. The drive assembly of claim 11, wherein the drive device and the housing are enclosed within a common cylindrical sleeve or tube.

16. The drive assembly of claim 11, wherein the drive shaft extends from a body that is not received by the housing.
